(19) United States
(12) Patent Application Publication
(10) Pub. No.: US 2016/0104181 A1
(43) Pub. Date: Apr. 14, 2016

(54) SYSTEM AND METHOD OF IDENTIFYING AND SEGMENTING ONLINE USERS

(71) Applicant: Concert7, Tortola (GB)

(72) Inventors: Subhra Jyoti Das, Dubai (AE); Manoj Nair, Hornsby (AU); Ramasubramaniam Barathy, Bangalore (IN)

(21) Appl. No.: 14/853,046

(22) Filed: Sep. 14, 2015

(30) Foreign Application Priority Data
Sep. 14, 2014 (IN) 4483/CHE/2014

(51) Int. Cl. G06Q 30/02; G06Q 50/00

(52) U.S. Cl. CPC G06Q 30/0204; G06Q 50/01

(57) ABSTRACT

A processor implemented method for identifying and segmenting a plurality of online users based on a level of engagement with respect to at least one user group is provided. The method includes obtaining, information associated with one or more user from one or more user groups, computing, one or more parameter of one or more user based on the information associated with the one more user, dynamically obtaining, a score for the one or more user based on one or more parameter, and segmenting, the plurality of online users from the one or more user groups based on the score for the one or more user to obtain a subset of the plurality of online users from the one or more user group including (a) a highest first level of engagement, (b) a second highest level of engagement, and (c) a third highest level of engagement.

### CROSS-REFERENCE TO RELATED APPLICATIONS

This application claims priority to Indian patent application no. 4483/CHE/2014 filed on Sep. 14, 2014 the complete disclosure of which, in its entirely, is herein incorporated by reference.

### BACKGROUND

1. Technical Field

The embodiments herein generally relate to data management system, and, more particularly, to system and method of identifying and segmenting a plurality of online users based on a level of engagement with respect to one or more user groups.

2. Description of the Related Art

Social media are computer-mediated tools supports an interaction among people in which they create, share or exchange information and ideas in virtual communities and networks. A social network is a platform to build relationships among people who share interests, activities, backgrounds or real-life connections. The social network includes a representation of each user (e.g., a profile), his/her social links, and a variety of additional services. The social network service plays a key role in enabling artists, brands, businesses etc to connect with their target audience. Today fans/users are not the focus of attention but about those celebrities. But the world has given importance to celebrities only. There are lots of digital music fans in the world and nobody knows who is really a music fan and who is not. So the target mechanism of artists and music brands is very unsystematic. There exists a difficulty in differentiating better fans compared to the normal. Similarly, the artists in today's world are not making money and most of them are struggling to meet their ends. Accordingly, there remains a need for a system to determine targeted persons in a social media efficiently with better differentiation.

### SUMMARY

In view of the foregoing, an embodiment herein provides a processor implemented method for identifying and segmenting a plurality of online users based on a level of engagement with respect to at least one user group. The method includes (i) obtaining, information associated with one or more user from one or more user groups, (ii) computing, one or more parameter of one or more user from the one or more user groups based on the information associated with the one more user from the one or more user groups, (iii) dynamically obtaining, a score for the one or more user from the one or more user groups based on one or more parameter, (iv) segmenting, the plurality of online users from the one or more user groups based on the score for the one or more user to obtain a subset of the plurality of online users from the one or more user group including (a) a highest first level of engagement, (b) a second highest level of engagement, and (c) a third highest level of engagement, and (v) providing, one or more reward to the subset of the plurality of online users based on the one or more parameter and the score for one or more user. The one or more user belongs to the one or more user groups. The score for the one or more user is valid for specific period of time.

The processor implemented method may further include dynamically monitoring, at a server, a status associated with the subset of the plurality of online users to update the level of engagement of the plurality of online users with respect to the one or more user groups. The one or more parameter may be (i) an influence level of one or more user from the one or more user group, (ii) one or more critique of the one or more user from one or more user groups in a social medium, or (iii) a promotion level of the one or more user from the one or more user groups at the social medium. The one or more user may be at least one of (i) a follower, (ii) a friend, (iii) connections, (iv) one who likes a page, (v) influencer, (vi) a blogger, (vii) a fan, (viii) a musician, (ix) an artist, (x) a celebrity, (xi) a customer, (xii) a seller, (xiii) a buyer, or (xiv) a promoter. The influence level of the one or more user may be computed based on (i) number of viewers associated with the one or more user in the social medium, (ii) number of review received on at least one post by the one or more user, (iii) number of comments received on at least one post by the one or more user, or (iv) number of times one or more user being notified in the social medium. The one or more critique of the one or more user may be computed based on at least one of (i) interest level associated with the one or more user, (ii) selecting genres of interest by the one or more user, (iii) recommendations of a social media content by the one or more user, or (iii) activity associated with the one or more user on the social media content.

The promotion level of the one or more user may be computed based on how much the one or more user promotes the social media content within one or more connections at the social medium. The promotion level of one or more user may be computed based on (i) rating and sharing of the social media content by the one or more user, (ii) tag the social media content by the one or more user, (iii) retweets article associated with the social media content in the social medium, or (iv) the one or more user invites the plurality of online users to join and promote.

In another aspect, a server for identifying and segmenting a plurality of online users based on a level of engagement with respect to at least one user group is provided. The server includes (i) a memory unit that stores (a) a set of modules, (b) a database and instructions, and (ii) a processor which when configured by the instructions executes the set of modules. The set of modules includes (a) an influence level computing module, executed by the processor, that computes a influence level of one or more user from the one or more user group, (b) a critique level computing module executed by the processor, that computes one or more critique of the one or more user from the one or more user group in a social medium, (c) a promotional information computing module, executed by the processor, that computes promotion level at the social medium of the one or more user from the one or more user groups, (d) a scoring module, executed by the processor, that dynamically obtaining, a score for the one or more user from the one or more user groups based on the one or more parameter, and (e) a user segmenting module, executed by the processor, that segments the plurality of online users from one or more user groups based on the score to obtain a subset of the plurality of online users from the one or more user group including (a) a highest first level of engagement, (b) a second highest level of engagement, and (c) a third highest level of engagement. The database includes (i) information associated with the one or more user groups, and (ii) information associated with the one or more parameter. The one or more user belongs to the one or more user groups. The score for the one or more user is valid for specific period of time.

The server may further include a user status updating module, executed by the processor, that dynamically monitor, at a server, a status associated with the subset of the plurality of online users to update the level of engagement of the plurality of online users with respect to the one or more user group. The influence level of the one or more user may be computed based on (i) number of viewers associated with the one or more user in the social medium, (ii) number of review received on at least one post by the one or more user, (iii) number of comments received on at least one post by the one or more user, or (iv) number of times one or more user being notified in the social medium. The one or more critique of the one or more user may be computed based on at least one of (i) interest level associated with the one or more user, (ii) selecting genres of interest by the one or more user, (iii) recommendations of a social media content by the one or more user, or (iii) activity associated with the one or more user on the social media content. The promotion level of the one or more user may be computed based on how much the one or more user promotes the social media content within one or more connections at the social medium. The promotion level of one or more user may be computed based on (i) rating and sharing of the social media content by the one or more user, (ii) tag the social media content by the one or more user, (iii) retweets article associated with the social media content in the social medium, or (iv) the one or more user invites the plurality of online users to join and promote. The server may further include a reward offering module, executed by the processor, that provide one or more reward to the subset of the plurality of online users based on the one or more parameter and the score for the one or more user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates a system view of a user management application interacts with one or more user group through social medium for identifying and segmenting plurality of online users based on a level of engagement with respect to the at least one user group according to an embodiment herein;

FIG. 1B is a exemplary view illustrates the user management application interacts with the server through the social medium for identifying and segmenting the plurality of online users based on a level of engagement with respect to the one or more user group according to an embodiment herein;

FIG. 2 illustrates an exploded view of the user management application of FIG. 1 according to an embodiment herein;

FIG. 3 illustrates a table view of identifying and managing the plurality of online users according to an embodiment herein;

FIG. 4 is a flow diagram illustrates a method of identifying and segmenting the plurality of online users based on the level of engagement with respect to the one or more user group according to the embodiments herein;

FIG. 5 illustrates an exploded view of the computing device according to the embodiments herein; and

FIG. 6 a schematic diagram of computer architecture used in according to the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

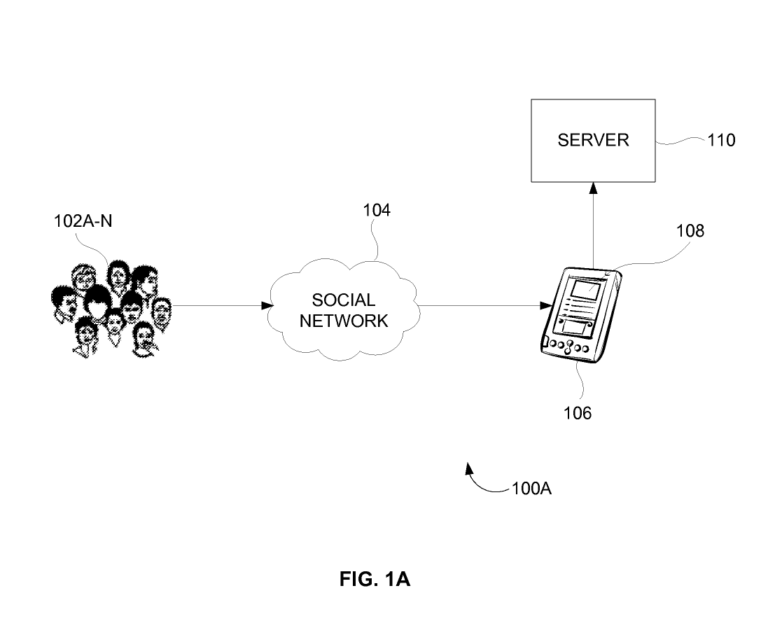

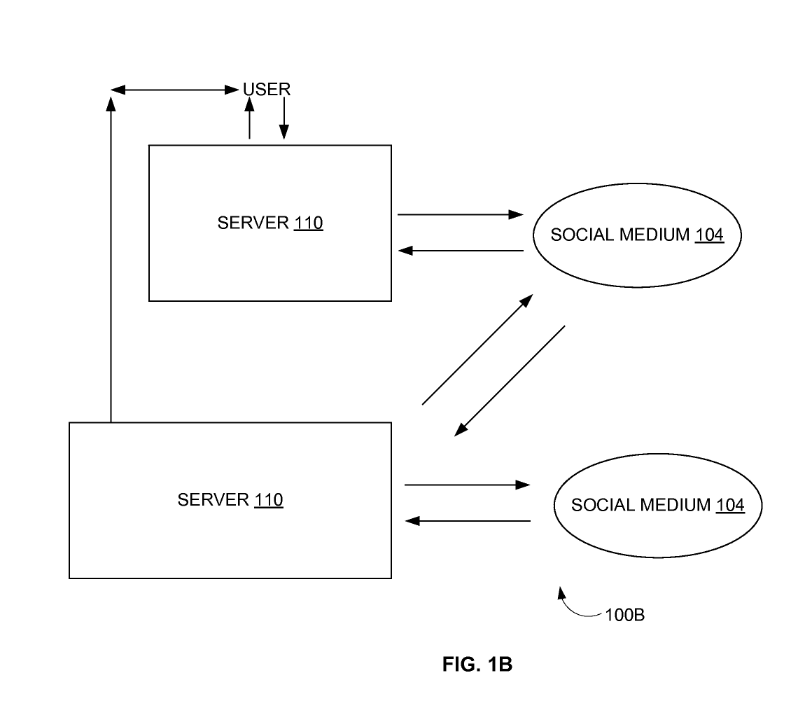

Accordingly, a need for a system to determine targeted persons in a social media efficiently with better differentiation. The embodiments herein achieve this by providing a user management application. The user management application which interacts with social medium to identify and segment one or more online users based on a level of engagement with respect to at least one user group. The level of engagement with respect to the one or more user group is obtained based on at least one parameter. The one or more parameters are at least one of (i) an influence level of at least one user, (ii) at least one critic of the at least one user from the at least one user group in a social medium, and (iii) a promotion level of the at least one user from the at least one user group at the social medium. A score is provided to the at least one user based on the one or more parameter. Based on the score, the plurality of online users is segmented to obtain a subset of the plurality of online users from the one or more user group. Referring now to the drawings, and more particularly to FIGS. 1 through 6, where similar reference characters denote corresponding features consistently throughout the figures, there are shown preferred embodiments.

FIG. 1A illustrates a system view 100A of a user management application 108 interacts with one or more user group 102A-N through a social medium 104 for identifying and segmenting plurality of online users based on a level of engagement with respect to the one or more user group 102A-N according to an embodiment herein. The system view 100A includes the one or more user group 102A-N, the social medium 104, a computing device 106, the user management application 108, and a server 110. In one embodiment, the one or more user (e.g., one or more online users) belongs to one or more user group 104A-N. The one or more user group 102A-N may include a user, a follower, a friend, one or more connection, one who likes a page in a social medium, an influencer, critic, a blogger, a fan, a musician, an artist, a celebrity, a customer, a seller, a buyer, and a promoter. In one embodiment, the social medium 104 is a social networking sites (e.g., Facebook©/Twitter©/YouTube, Blogger). In one embodiment, the computing device 106 may be a smart device, a smart phone, a tablet PC, a laptop, a personal computer, and/or an ultra book. The user management application 108 which interacts with the one or more user group 102A-N through the social medium 104 to identify and segment the plurality of online users based on the level of engagement with respect to one or more user group 104A-N.

The level of engagement with respect to one or more user group 104A-N is obtained based on one or more parameters. The one or more parameters are at least one of (i) an influence level of the one or more user, (ii) at least one critique of the one or more user from the one or more user group 102A-N in the social medium 104, and (iii) a promotion level of the one or more user from the one or more user group 102A-N at the social medium 104. A score is dynamically provided to the one or more user from the one or more user group 102A-N based on the one or more parameter. In one embodiment, the score for one or more user is valid for a specific period of time (e.g., a specific hours, a day, in a week, or a month). For example, a score by which a fan can be determined that how strong a music fan he/she is. Based on the score, the plurality of online users is segmented to obtain a subset of the plurality of online users from the one or more user group. The subset of plurality of online users (e.g., one or more fan associated with music) includes at least one of (i) a highest first level of engagement, (ii) a second highest level of engagement, and (iii) a third highest level of engagement. For example, based on the calculated score (fanscore), one or more fan may be segmented as (i) super fans, (ii) hardcore fans, and (iii) top fans respectively. Similarly, one or more fans can be categorized based on the calculated score but not limited to at least one of (a) geography, (b) age, (c) activity types.

In one embodiment, the scoring of a fan may be associated with music but not limited to movies, and sports. The subset of the plurality of online users receives one or more reward (e.g., discount on purchasing ticket to attend a music concert) based on the one or more parameter and the score for the one or more user. In one embodiment, the fanscore may be dynamically calculated and categorized based on change in three components (e.g., between zero to hundred) through which higher score having higher fan strength and vice-versa. In one embodiment, different weights are assigned to different activities in each of the component to arrive at the fan score. In one embodiment, the user management application 108 is executed in the computing device 106. In another embodiment, the user management application 108 is executed in the server 110.

FIG. 1B is a exemplary view illustrates the user management application 108 interacts with the server 110 through the social medium 104 for identifying and segmenting the plurality of online users based on the level of engagement with respect to the one or more user group 102A-N according to an embodiment herein. The exemplary view 100B includes the server 110, and the social medium 104. The user management application 108 obtains from a database the information associated with the one or more user from the one or more user group 102A-N. In one embodiment, information associated with the one or more user includes user login credentials (e.g., a user name, password). The server 110 which dynamically tracks the activity of the one or more user from the user group 102A-N (e.g., when the user login in the social network 104). In one embodiment, the server 110 may immediately provide a score for fan once the user login in the social medium 104.

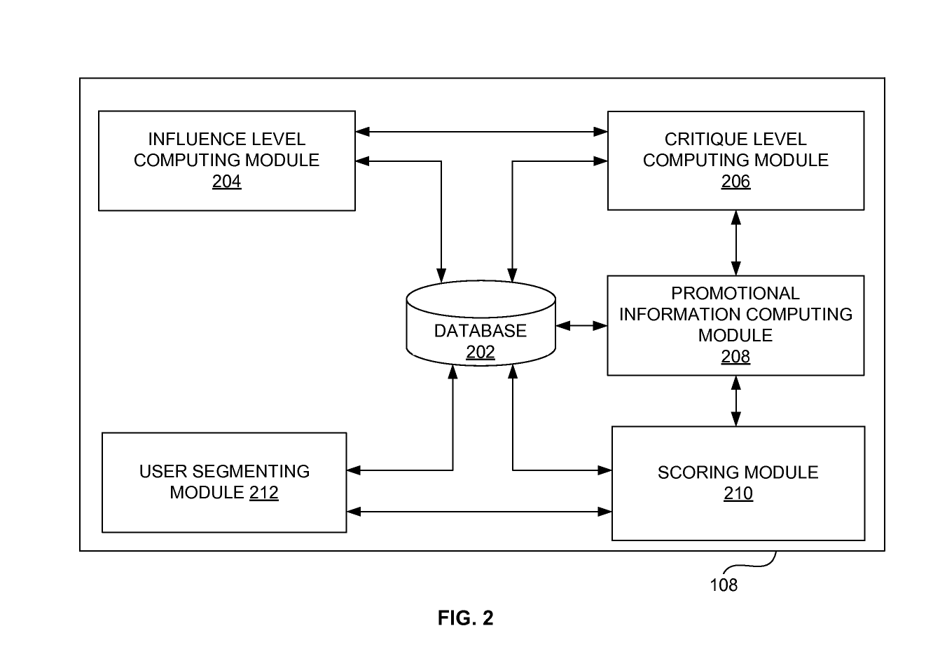

FIG. 2 illustrates an exploded view of the user management application 108 of FIG. 1 according to an embodiment herein. The user management application 108 includes a database 202, an influence level computing module 204, a critic level computing module 206, promotional information computing module 208, a scoring module 210, and a user segmenting module 212. The database 202 which stores (i) one or more information associated with the one or more user group 102A-N, and (ii) information associated with the one or more parameters. The influence level computing module 204 which compute influence level (I) of one or more user from the one or more user group 102A-N. In one embodiment, the one or more user belongs to the one or more user group 102A-N.

The influence level is computed based on at least one of (i) number of viewers associated with the one or more user in the social medium 104, (ii) number of review received on at least one post by the one or more user, (iii) number of comments received on at least one post by the one or more user, or (iv) number of times the one or more user being notified in the social medium 104. For example, the influence level is measure of how much he/she influential in a music space. The influence level may be at least one of (i) the number of friends/followers/readers in his/her network (e.g. Facebook©/Twitter©/YouTube™, blogs), (ii) number of likes/comments received on posts by him/her, and (iii) number of times others mentioning him/her in a social networking sites.

The critique level computing module 206 computes at least one critic of the one or more user from the one or more user group 102A-N in the social medium 104. The one or more critics associated with the one or more user is computed based on at least one of (i) interest level associated with the one or more user, (ii) selecting genres of interest by the one or more user, (iii) recommendations of a social media content by the one or more user, or (iii) activity associated with the one or more user on the social media content. For example, the one or more critics is at least one of (i) he/she mentioned music interest (e.g. Facebook©/Twitter©/blogs) (ii) he/she actively chooses genres of interest, (iii) he/she rates, reviews, writes, blogs, creates playlists curates on music related activities, and (iv) listening/watching/doing music related items. For example, critics may be a measure of how much he/she talks/writes/listens/rates/reviews and gives feedback about music. In one embodiment, score may increase whenever he/she does any critic.

The promotional information computing module 208 that computes promotion level at the social medium 104 of the one or more user from the one or more user group 104A-N. The promotional information is computed based on at least one of (i) rating and sharing of the social media content by the one or more user, (ii) the social media content is tagged by the one or more user, (iii) retweets article associated with the social media content in the social medium 104, and (iv) the one or more user invites the plurality of online users to join and promote. For example, the promotional information is at least one of (i) he/she rates and shares music related content i.e., he/she likes/comments posts on music related activities/artists messages which is visible, (ii) he/she tags/retweets music related articles/people/creations in different networks, (iii) he/she creates playlists or shares what he is listening to and open up for others to use, and (iv) he/she invites others to join/like/purchase and further promote.

The scoring module 210 that dynamically obtain a score for the one or more user from the one or more user group 102A-N based on the one or more parameter. In one embodiment, the score for one or more user is valid for a specific period of time (e.g., a specific hours, a day, in a week, or a month). For example, the score by which a fan can determine how strong a music fan he/she is. The user segmenting module 212 that segments the plurality of online users from the one or more user group 102A-N based on the score to obtain a subset of the plurality of online users from the one or more user group 102A-N having (i) a highest first level of engagement, (ii) a second highest level of engagement, and (iii) a third highest level of engagement. In one embodiment, the subset of plurality of online users (e.g., one or more fan associated with music) may include at least one of (i) the highest first level of engagement, (ii) the second highest level of engagement, and (iii) the third highest level of engagement.

For example, based on the calculated score, one or more fan may be segmented as (i) super fans, (ii) hardcore fans, (iii) top fans. In one embodiment, the scoring of a fan may be associated with music but not limited to movies, and sports. The subset of the plurality of online users receives one or more reward (e.g., discount on purchasing ticket to attend a music concert) based on the one or more parameter and the score for the one or more. In an example embodiment, a token of appreciation is provided to the super fans for personally meeting their favorite music celebrity based on the calculated score and the one or more parameters.

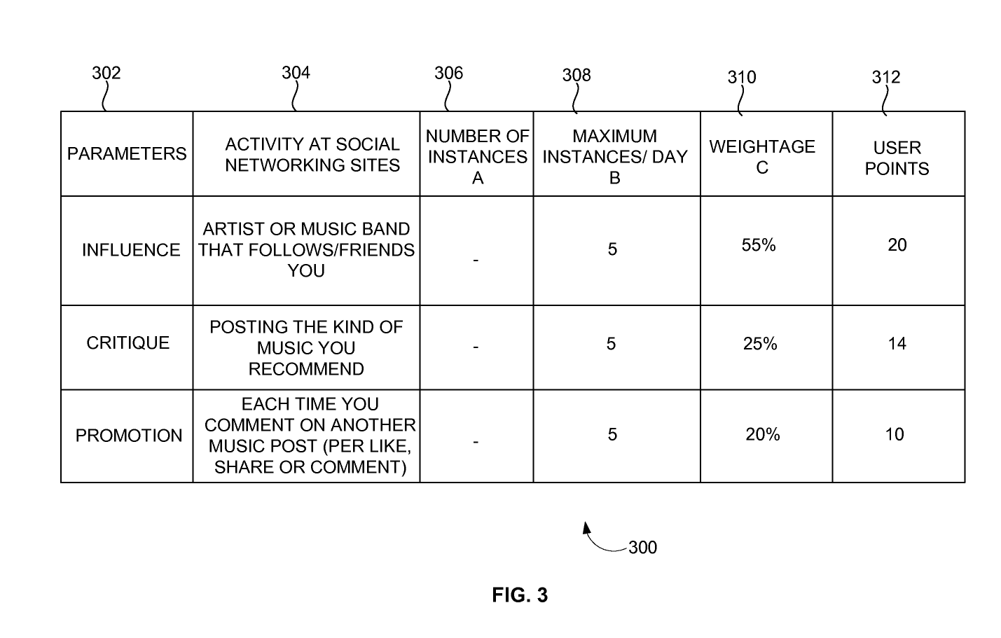

FIG. 3 illustrates a table view of identifying and managing the plurality of online users according to an embodiment herein. The table view 300 includes a parameters field 302, an activity on social networking sites field 304, a number of instances field 306, maximum instances field 308, a weightage field 310, and a user points field 312. The parameters field 302 includes the one or more parameters (i) influence level, (ii) critic, and (iii) promotion level for computing scores. The activity on social networking sites field 304 which includes a list of activities performed by the user group 102 in the social medium 104. For example, for the influence level and corresponding activity on the social networking sites field 304 is “artist or music band those follows/friends him/her”. Then the weightage field 310 in which weightage 55% is given when maximum number of instances is five and corresponding user point is 20.

Similarly, for the critic and corresponding activity on the social networking sites field 304 is “posting kind of music he/she recommend”. Then the weightage field 310 in which weightage 25% is given when maximum number of instances is five and corresponding user point is 14. Similarly, for the promotion level and corresponding activity on the social networking sites field 304 is “each time he/she comment on another music post (like, share or comment)”. Then the weightage field 310 in which weightage 20% is given when maximum number of instances is five and corresponding user point is 10 in the user point field 312.

For example, the influence level which include one or more sub parameters in one or more social medium as follows at least one of (i) each new super fans and hardcore fan he/she follow, (ii) each new fan or hardcore fan or super fan that follows him/her, (iii) any new friend that he/she invite, (iv) any new friend that is added in his/her social medium, (v) any artist or music label or music band that follows or befriends him/her on social medium, (vi) each time he/she music post gets commented on (per like, share or comment), (vii) each time anyone he/she are mentioned in any of the remarks, (viii) any new social medium follower that he/she add, (ix) any artist or music label or music band that follows he/she on social medium, (x) each time he/she music related tweet is retweeted or replied to (per retweets or reply), and (xi) each like, comment or rating received for the content he/she uploaded on YouTube™.

Similarly, the influence level which include one or more sub parameters in one or more music networks and blogs are as follows, (i) each new follower added on other music networks, (ii) each time his/her content getting rated or comments on within these networks, (iii) each time his/her post on music gets liked, commented or shared within these networks, (iv) each blog that he/she have related to music under his/her social network, (v) each new follower in that blog(s), and (vi) each new comment received in that blog(s).

Similarly, the critic level which include one or more sub parameters in one or more social network are as follows (i) posting his/her music thoughts, (ii) posting the kind of music he/she recommend, (iii) each time he/she post something to do with music (keyword based), (iv) each time he/she comment on another music post (per like, share or comment), (v) each time he/she comment on a post on the artist page, (vi) when he/she add music interest to his/her social network, (vii) each time he/she tweet about music with any of the relevant hash tags (keyword based), and (viii) each time he/she participate in a rating activity on a music related video on YouTube™ using that username. Similarly, the critic level which include one or more sub parameters in one or more music networks and blogs are as follows, (i) each time he/she comment/rate on other music content on such networks, and (ii) for each comment that he/she gives in such blogs.

Similarly, the promotion level information which include one or more sub parameters in one or more social network are as follows, (i) sharing of his/her fanscore, (ii) each time he/she update his/her profile, (iii) sharing any item of his/her feed, (iv) each time he/she comment on another music post (per like, share or comment), (v) when he/she like music in his/her social network, (vi) when he/she follow a music artist, music band or music label or music company, (vii) each time he/she retweets or reply to a music tweet from the music list that he/she follow, (viii) each time he/she upload a music content on YouTube™ using the same profile. Similarly, the promotion level information which include one or more sub parameters in the musical network and blogs are as follows (i) each new music network he/she sign up, (ii) when he/she give access to each such music network to find out his/her tastes in music, and (iii) when he/she use your social network profile and participate in blogs.

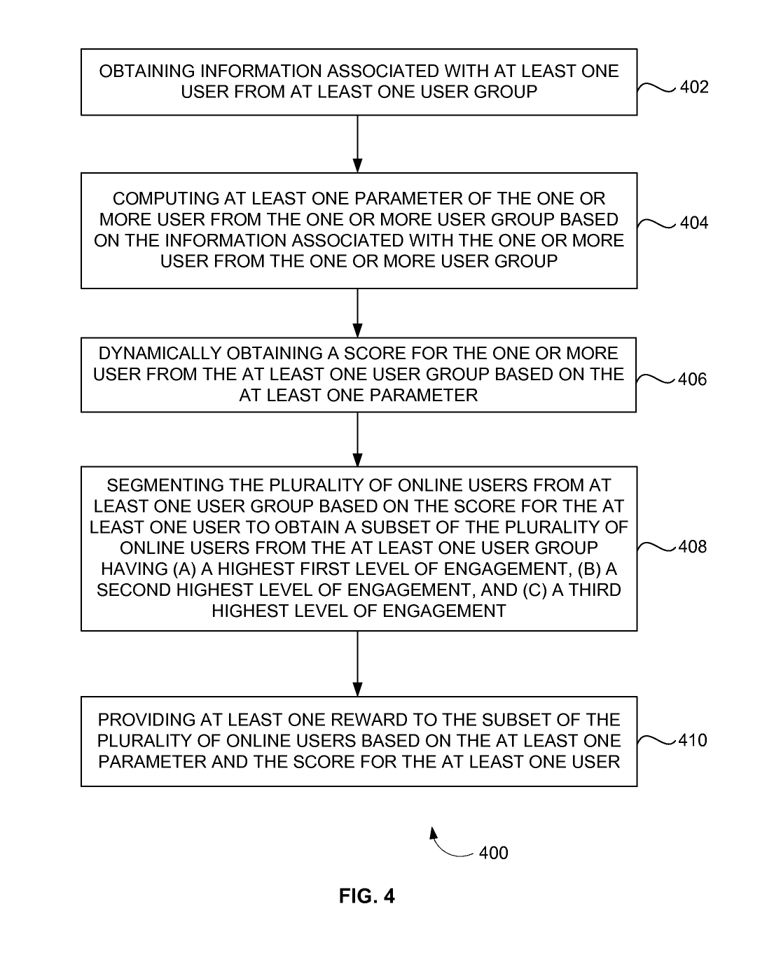

FIG. 4 is a flow diagram illustrates a method of identifying and segmenting the plurality of online users based on the level of engagement with respect to the one or more user group 102A-N according to the embodiments herein. In step 402, information associated with one or more user from the one or more user group 102A-N is obtained. In step 404, at least one parameter of the one or more user from the one or more user group 102A-N is computed based on the information associated with one or more user from the one or more user group 102A-N. In one embodiment, the one or more user belongs to the one or more user group 102A-N. In step 406, a score for the one or more user from the one or more user group 102A-N is dynamically obtained based on the one or more parameter. In one embodiment the score for the one or more user is valid for specific period of time. In step 408, the plurality of online users from the one or more user group 102A-N is segmented based on the score for the one or more user to obtain a subset of the plurality of online users from the one or more user group 102A-N having (i) a highest first level of engagement, (ii) a second highest level of engagement, and (iii) a third highest level of engagement.

In step 408, at least one reward is provided to the subset of the plurality of online users based on the one or more parameter and the score for the one or more user. The one or more parameter is at least one of (i) an influence level of the one or more user from the one or more user group 102A-N, (ii) A one or more critic of the one or more user from the one or more user group 102A-N in the social medium 104, and (iii) a promotion level of the one or more user from the one or more user group 102A-N at the social medium 102A-N. The server 110 monitors a status associated with the subset of the plurality of online users based on the one or more parameter and the score of the one or more user to update the level of engagement of the plurality of online users with respect to the one or more user group 102A-N. For example, user A is named as “a top fan” of “jazz music” in a music category for a specific time period. Then, the status associated with the user A can be upgraded to “a super fan” based on the one or more parameter and the score of the one or more user. Similarly, user B is named as “a super fan” to cricket game in a sports category for a specific time period. Then, the status associated with the user B can be less prioritized as “a top fan” instead of “super fan” based on the one or more parameter and the score of the one or more user.

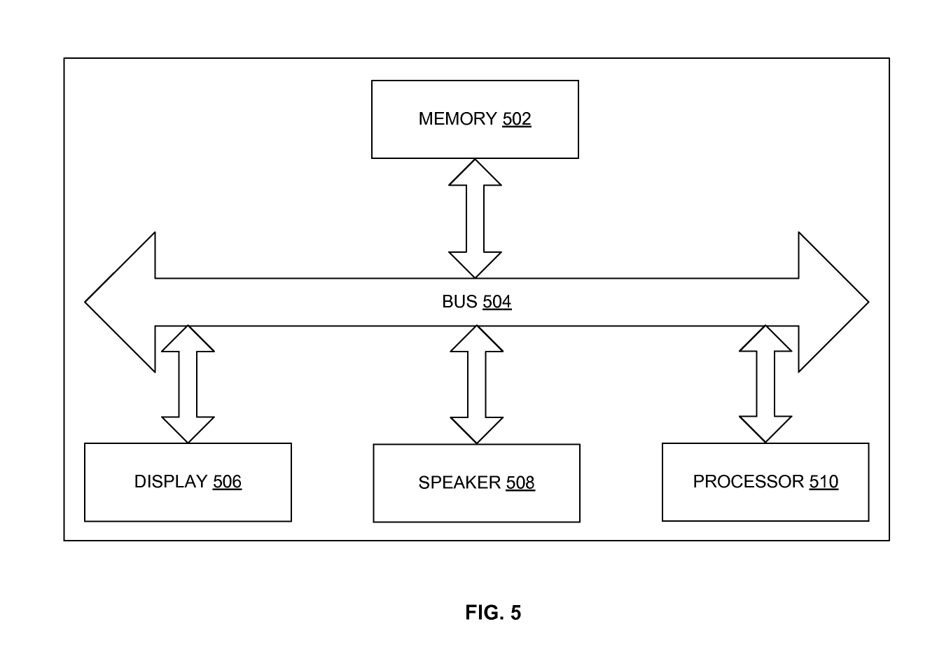

FIG. 5 illustrates an exploded view of the computing device 106 having an a memory 502 having a set of computer instructions, a bus 504, a display 506, a speaker 508, and a processor 510 capable of processing a set of instructions to perform any one or more of the methodologies herein, according to an embodiment herein. In one embodiment, the receiver may be the computing device 106. The processor 510 may also enable digital content to be consumed in the form of video for output via one or more displays 506 or audio for output via speaker and/or earphones 508. The processor 510 may also carry out the methods described herein and in accordance with the embodiments herein.

Digital content may also be stored in the memory 502 for future processing or consumption. The memory 502 may also store program specific information and/or service information (PSI/SI), including information about digital content (e.g., the detected information bits) available in the future or stored from the past. A user of the computing device 106 may view this stored information on display 506 and select an item of for viewing, listening, or other uses via input, which may take the form of keypad, scroll, or other input device(s) or combinations thereof. When digital content is selected, the processor 510 may pass information. The content and PSI/SI may be passed among functions within the computing device 106 using the bus 504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

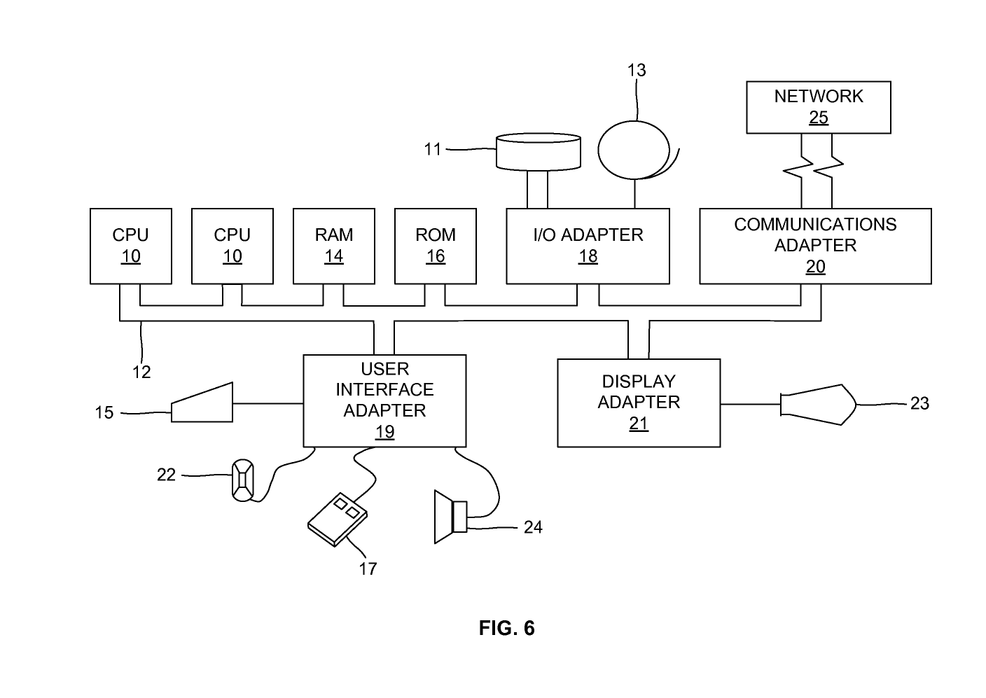

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The user management application 108 support in segmenting the crowd. The user management application helps in systematically target fans by segmentation method. The user management application create the scores based on influence, critique, promotion is valuable to different people. Similarly, based on the segmentation as next step is recommendation. Based on performing fanscore and then connecting the right fans to the right artists, solve the problem of obscurity of artists.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor implemented method for identifying and segmenting a plurality of online users based on a level of engagement with respect to at least one user group, said method comprising:
obtaining, information associated with at least one user from said at least one user group;
computing, at least one parameter of said at least one user from said at least one user group based on said information associated with said at least one user from said at least one user group, wherein said at least one user belongs to said at least one user group;
dynamically obtaining, a score for said at least one user from said at least one user group based on said at least one parameter, wherein said score for said at least one user is valid for specific period of time;
segmenting, said plurality of online users from said at least one user group based on said score for said at least one user to obtain a subset of said plurality of online users from said at least one user group comprising (i) a highest first level of engagement, (ii) a second highest level of engagement, and (iii) a third highest level of engagement; and
providing, at least one reward to said subset of said plurality of online users based on said at least one parameter and said score for said at least one user.

2. The processor implemented method of claim 1, further comprising, dynamically monitoring, at a server, a status associated with said subset of said plurality of online users to update said level of engagement of said plurality of online users with respect to said at least one user group.

3. The processor implemented method of claim 1, wherein said at least one parameter is at least one of (i) an influence level of said at least one user from said at least one user group, (ii) at least one critique of said at least one user from at least one user group in a social medium, or (iii) a promotion level of said at least one user from said at least one user group at said social medium.

4. The processor implemented method of claim 1, wherein said at least one user is selected from a group comprising (i) a follower, (ii) a friend, (iii) connections, (iv) one who likes a page, (v) influencer, (vi) a blogger, (vii) a fan, (viii) a musician, (ix) an artist, (x) a celebrity, (xi) a customer, (xii) a seller, (xiii) a buyer, or (xiv) a promoter.

5. The processor implemented method of claim 3, wherein said influence level of said at least one user is computed based on at least one of (i) number of viewers associated with said at least one user in said social medium, (ii) number of review received on at least one post by said at least one user, (iii) number of comments received on at least one post by said at least one user, or (iv) number of times said at least one user being notified in said social medium.

6. The processor implemented method of claim 3, wherein said at least one critique of said at least one user is computed based on at least one of (i) interest level associated with said at least one user, (ii) selecting genres of interest by said at least one user, (iii) recommendations of a social media content by said at least one user, or (iii) activity associated with said at least one user on said social media content.

7. The processor implemented method of claim 3, wherein said promotion level of said at least one user is computed based on how much said at least one user promotes said social media content within at least one connections at said social medium.

8. The processor implemented method of claim 5, wherein said promotion level of said at least one user is computed based on at least one of (i) rating and sharing of said social media content by said at least one user, (ii) said social media content is tagged by said at least one user, (iii) retweets article associated with said social media content in said social medium, or (iv) said at least one user invites said plurality of online users to join and promote.

9. A server for identifying and segmenting a plurality of online users based on a level of engagement with respect to at least one user group, said server comprising:
(i) a memory unit that stores (a) a set of modules, (b) a database and instructions, wherein said database comprises (i) information associated with said at least one user group, and (ii) information associated with at least one parameter; and
(ii) a processor which when configured by said instructions executes said set of modules, wherein said set of modules comprises:
(a) an influence level computing module, executed by said processor, that computes a influence level of at least one user from said at least one user group, wherein said at least one user belongs to said at least one user group;
(b) a critique level computing module executed by said processor, that computes at least one critique of said at least one user from said at least one user group in a social medium;
(c) a promotional information computing module, executed by said processor, that computes promotion level at said social medium of said at least one user from said at least one user group;
(d) a scoring module, executed by said processor, that dynamically obtaining, a score for said at least one user from said at least one user group based on said at least one parameter, wherein said score for said at least one user is valid for specific period of time; and
(e) a user segmenting module, executed by said processor, that segments said plurality of online users from said at least one user group based on said score to obtain a subset of said plurality of online users from said at least one user group comprising (i) a highest first level of engagement, (ii) a second highest level of engagement, and (iii) a third highest level of engagement.

10. The server of claim 9, further comprises, a user status updating module, executed by said processor, that dynamically monitor, at a server, a status associated with said subset of said plurality of online users to update said level of engagement of said plurality of online users with respect to said at least one user group.

11. The server of claim 9, wherein said influence level of said at least one user is computed based on at least one of (i) number of viewers associated with said at least one user in said social medium, (ii) number of review received on at least one post by said at least one user, (iii) number of comments received on at least one post by said at least one user, or (iv) number of times said at least one user being notified in said social medium.

12. The server of claim 9, wherein said at least one critique of said at least one user is computed based on at least one of (i) interest level associated with said at least one user, (ii) selecting genres of interest by said at least one user, (iii) recommendations of a social media content by said at least one user, or (iii) activity associated with said at least one user on said social media content.

13. The server of claim 9, wherein said promotion level of said at least one user is computed based on how much said at least one user promotes said social media content within at least one connections at said social medium.

14. The server of claim 13, wherein said promotion level of said at least one user is computed based on at least one of (i) rating and sharing of said social media content by said at least one user, (ii) said social media content is tagged by said at least one user, (iii) retweets article associated with said social media content in said social medium, or (iv) said at least one user invites said plurality of online users to join and promote.

15. The server of claim 9, further comprises, a reward offering module, executed by said processor, that provide at least one reward to said subset of said plurality of online users based on said at least one parameter and said score for said at least one user.

16. A non-transitory program storage device readable by computer, and comprising a program of instructions executable by said computer to perform a method for identifying and segmenting a plurality of online users based on a level of engagement with respect to at least one user group, said method comprising:
obtaining, information associated with at least one user from said at least one user group;
computing, at least one parameter of said at least one user from said at least one user group based on said information associated with said at least one user from said at least one user group, wherein said at least one user belongs to said at least one user group;
dynamically obtaining, a score for said at least one user from said at least one user group based on said at least one parameter, wherein said score for said at least one user is valid for specific period of time;
segmenting, said plurality of online users from said at least one user group based on said score for said at least one user to obtain a subset of said plurality of online users from said at least one user group comprising (i) a highest first level of engagement, (ii) a second highest level of engagement, and (iii) a third highest level of engagement;
providing, at least one reward to said subset of said plurality of online users based on said at least one parameter and said score for said at least one user;
dynamically monitoring, at a server, a status associated with said subset of said plurality of online users to update said level of engagement of said plurality of online users with respect to said at least one user group; and
computing a promotion level of said at least one user based on how much said at least one user promotes social media content within at least one connections at social medium.
